(19) United States
(12) Patent Application Publication
(10) Pub. No.: US 2023/0070603 A1
(43) Pub. Date: Mar. 9, 2023

(54) POLYAMIDE RESIN COMPOSITION AND MOLDED ARTICLE MANUFACTURED USING THE SAME

(71) Applicants: Hyundai Motor Company, Seoul (KR); Kia Corporation, Seoul (KR); KTP Industries, Inc., Gimcheon (KR)

(72) Inventors: Seul Yi, Seoul (KR); Boo Youn An, Hwaseong (KR); Dae Sik Kim, Yongin (KR); Kyeong Hoon Jang, Seoul (KR); In Soo Han, Uiwang (KR); Jin Gi Ahn, Seoul (KR); Seong Hyun Myung, Daegu (KR); Seong Jun Yu, Gimcheon (KR); Jung Hyun Yoo, Gumi (KR); Ki Bong Jung, Daegu (KR)

(21) Appl. No.: 17/882,985

(22) Filed: Aug. 8, 2022

(30) Foreign Application Priority Data
Aug. 17, 2021 (KR) 10-2021-0107817

(51) Int. Cl. C08G 69/14; C08F 279/04; C08K 3/40; C08K 7/14; C08G 73/12

(52) U.S. Cl. CPC C08G 69/14; C08F 279/04; C08K 3/40; C08K 7/14; C08G 73/12; C08K 2201/003; C08K 2201/004

(57) ABSTRACT

Disclosed are a polyamide resin composition and a molded article manufactured using the same. The molded article may have excellent mechanical strength, deformation resistance and light resistance, and may be suitable for use without coating. The polyamide resin composition includes a polyamide resin, an auxiliary resin (e.g., an acrylonitrile-butadiene-styrene copolymer), a filler (e.g., glass fibers and glass beads), and a compatibilizer (e.g., copolymer including maleimide).

### CROSS-REFERENCE TO RELATED APPLICATION

This application claims under 35 U.S.C. § 119(a) the benefit of priority to Korean Patent Application No. 10-2021-0107817, filed on Aug. 17, 2021, the entire contents of which are incorporated herein by reference.

### TECHNICAL FIELD

The present invention relates to a polyamide resin composition and a molded article manufactured using the same. The molded article may have excellent mechanical strength, deformation resistance and light resistance, and may be suitable for use without coating, manufactured using the polyamide resin composition. The composition may suitably include a polyamide resin, an auxiliary resin such as an acrylonitrile-butadiene-styrene copolymer, a filler such as glass fibers and glass beads, and a compatibilizer such as a copolymer including maleimide.

### BACKGROUND

Engineering plastic materials have been widely used in various fields in place of conventionally used metals. For example, engineering plastic materials are used as automobile interior and exterior materials, and the range of parts to which they are applied and the demand therefor are continually increasing. Accordingly, in order to satisfy the characteristics required for the field, to which the products are applied, for application to various parts, research to improve the characteristics of engineering plastics is continuously being conducted.

In recent years, the number of automobile parts using uncoated products manufactured without a coating process has been gradually increasing, for example, due to reduced processing time and cost.

In particular, one automobile part to which an uncoated nylon 6 (PA6) material is applicable is, for example, a defroster nozzle. Such a defroster nozzle can be used as an automobile interior part for a long period of time without deformation, and thus it requires excellent mechanical strength, dimensional stability, and surface properties. In addition, the defroster nozzle requires light resistance because it is constantly exposed to sunlight.

An alloy (PC/ABS) of polycarbonate and an amorphous graft copolymer has been used in the form of a coating as a conventional material for defroster nozzles, but may have dimensional changes due to moisture absorption and bending deformation due to the low strength thereof. In addition, this material inevitably increases costs because it requires a coating process after injection molding.

Therefore, there is need to develop a material that exhibits excellent mechanical strength, dimensional stability, and light resistance for application to automobile defroster nozzles and can be used in a product without being coated.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is a polyamide molded article having excellent mechanical strength.

In an aspect, provided is a polyamide molded article for use without coating having excellent deformation resistance and light resistance.

In an aspect, provided is polyamide molded article that can be used as a material for automobile interior materials or defroster nozzles.

The objects of the present invention are not limited to those described above. Other objects of the present invention will be clearly understood from the following description, and are able to be implemented by means defined in the claims and combinations thereof.

In one preferred aspect, provided is a polyamide resin composition including a polyamide resin, an auxiliary resin, a filler, and a compatibilizer. In particular, the compatibilizer may suitably include a copolymer including maleimide.

The polyamide resin may include nylon 6, nylon 66, or combinations thereof.

The polyamide resin may have a relative viscosity of about 2.0 to 3.6.

The auxiliary resin may have a melt index of about 15 to 50 g/10 min according to ASTM D1238.

The auxiliary resin may include an acrylonitrile 1,3-butadiene styrene copolymer.

The filler may include a glass fiber, a glass bead, or combinations thereof.

The glass fiber may include a milled glass fiber, and the glass fiber may have a diameter of about 10 to 13 μm and a length of about 50 to 500 μm.

The glass bead may have a particle diameter of about 10 to 50 μm.

The glass bead may include calcium oxide (CaO), silicon dioxide (SiO₂), aluminum oxide (Al₂O₃), or combinations thereof.

The compatibilizer may include an N-phenylmaleimide-styrene copolymer, a styrene-maleic anhydride copolymer, or combinations thereof.

The polyamide resin composition may further include an additive.

The polyamide resin composition may include the additive in an amount of about 0.5 to 3 parts by weight based on 100 parts by weight of the polyamide resin.

The polyamide resin composition may suitably include an amount of about 40 to 80% by weight of the polyamide resin, an amount of about 10 to 25% by weight of the auxiliary resin, an amount of about 9 to 30% by weight of the filler, and an amount of about 0.5 to 5% by weight of the compatibilizer, based on the total weight of the polyamide resin composition.

The polyamide resin composition may suitably include an amount of about 40 to 80% by weight of the polyamide resin, an amount of about 10 to 25% by weight of the auxiliary resin, an amount of about 5 to 20% by weight of the glass fiber, an amount of about 4 to 10% by weight of the glass bead, and an amount of about 0.5 to 5% by weight of the compatibilizer, based on the total weight of the polyamide resin composition.

In one preferred aspect, provided is a molded article including the polyamide resin composition as described herein.

Also provided is a vehicle including the molded article as described herein

Other aspects of the invention are discussed infra.

### DETAILED DESCRIPTION

The objects described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to encompass the plural meaning as well, unless the context clearly indicates otherwise.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Provided herein, inter alia, are a polyamide resin composition and a molded article including or manufactured using the same.

Hereinafter, each component included in the polyamide resin composition of the present invention will be described, and the physical properties of the molded article manufactured using the polyamide resin composition will be described with reference to experiments.

Polyamide Resin Composition

The polyamide resin composition may suitably include a polyamide resin, an auxiliary resin, a filler, and a compatibilizer.

Polyamide Resin

The polyamide resin according to the present invention may include nylon 6 (PA6), nylon 66 (PA66), or combinations thereof.

For example, the polyamide resin may have a relative viscosity of about 2.0 to 3.6 when it includes 1 g of a polyamide 6 resin in 100 ml of 96% sulfuric acid at a temperature of 20° C. Preferably, the relative viscosity may range from about 2.3 to about 3.2. When the relative viscosity of the polyamide resin is less than about 2.0, rigidity, dimensional stability, and impact resistance may be deteriorated, whereas when the relative viscosity of the polyamide resin is greater than about 3.6, fluidity becomes poor due to the high molecular weight, and exposure of the filler to the surface and molding failure occur.

The polyamide resin composition may suitably include an amount of about 40 to 80% by weight of the polyamide resin based on the total weight of the polyamide resin composition.

Auxiliary Resin

The auxiliary resin may preferably include an acrylonitrile 1,3-butadiene styrene copolymer.

The acrylonitrile 1,3-butadiene styrene copolymer is an amorphous polymer, and may delay crystallization of the polyamide resin, thereby securing appropriate molding shrinkage.

The auxiliary resin preferably has a melt index of about 15 to 50 g/10 min according to ASTM D1238. When the melt index is less than about 15 g/10 min, workability may be reduced, and when the melt index is greater than about 50 g/10 min, it may be difficult to secure mechanical properties.

The polyamide resin composition may suitably include an amount of about 10 to 25 wt % of the auxiliary resin based on the total weight of the polyamide resin composition.

Filler

The filler may suitably include a glass fiber, a glass bead, or combinations thereof, and preferably may include both a glass fiber and a glass bead.

The glass fiber may be shorter than that of a conventional glass fiber. For example, the glass fiber may preferably include a milled glass fiber, and the glass fiber may have a diameter of about 10 to 13 μm and a length of about 50 to 500 μm. When the diameter is less than about 10 the glass fiber may be easily broken and may not satisfactorily improve the rigidity, and when the diameter is greater than about 13 rigidity can be improved, but the appearance may be deteriorated due to a problem of protruding fibers. In addition, when the length is less than about 50 μm, the effect of reinforcing the rigidity may be insufficient, and when the length is about 500 μm or more, the appearance may be deteriorated or the product may be deformed.

The glass bead may have a spherical shape and preferably may have a particle diameter of about 10 to 50 μm.

The glass bead may suitably include calcium oxide (CaO), silicon dioxide (SiO₂), and aluminum oxide (Al₂O₃) and particularly may include an amount of about 10 to 20% by weight of the calcium oxide, an amount of about 50 to 70% by weight of the silicon dioxide and an amount of about 2 to 15% by weight of the aluminum oxide, based on the total weight of the glass bead.

The polyamide resin composition may suitably include an amount of about 9 to 30% by weight of the filler based on the total weight of the polyamide resin composition. The polyamide resin composition may preferably include an amount of about 5 to 20% by weight of the glass fiber and an amount of about 4 to 10% by weight of the glass bead based on the total weight of the polyamide resin composition. When the content of the filler is less than about 9% by weight, it may be difficult for the filler to exhibit mechanical properties and dimensional stability in the vertical direction of the resin flow, and when the content of the filler is greater than about 30% by weight, the cost and specific gravity may increase more than necessary.

Compatibilizer

The compatibilizer may increase the compatibility between polymer components of the polyamide resin and the auxiliary resin, may preferably include the acrylonitrile 1,3-butadiene styrene copolymer.

The compatibilizer may preferably include a copolymer including maleimide. Particularly, the compatibilizer may include an N-phenylmaleimide-styrene copolymer, a styrene-maleic anhydride copolymer, or combinations thereof.

The polyamide resin composition may suitably include an amount of about 0.5 to 5% by weight of the compatibilizer based on the total weight of the polyamide resin composition. When the content of the compatibilizer is less than about 0.5% by weight, compatibility between the polyamide resin and the auxiliary resin may be reduced, and when the content of the compatibilizer is greater than about 5% by weight, manufacturing costs may increase, and price competitiveness may decrease.

When compatibility is not secured, phase separation may occur between the polyamide and the polypropylene resin, causing a problem in which the cation concentration and electrical conductivity increase more than necessary due to the polyamide resin having high ion release compared to the polypropylene resin.

Additive

The polyamide resin may further include an additive as necessary, and the additive, for example, includes dyes, release agents, processing aids, UV stabilizers, weathering agents, and the like.

The additive may be present in an amount of about 0.5 to 3 parts by weight based on 100 parts by weight of the polyamide resin.

### EXAMPLE

Hereinafter, the present invention will be described in more detail with reference to specific examples. However, the following examples are provided only for better understanding of the present invention, and thus should not be construed as limiting the scope of the present invention.

### Preparation Example (Preparation of Specimen)

A polyamide resin, an acrylonitrile 1,3-butadiene styrene copolymer, a heat resistance agent, a glass bead, and a glass fiber were charged in a twin-screw extruder, and these ingredients were melt-kneaded with the twin-screw extruder heated to 200 to 260° C., molded into a chip form, and dried at a temperature of 85° C. in a dehumidifying dryer for 4 to 6 hours. Then, the polyamide resin composition was injected at the same temperature as in the melt kneading through a heated screw-type injection machine to produce a specimen.

### Examples and Comparative Examples

The compositions shown in Table 1 were prepared.

TABLE 1

| | Polyamide resin composition | | | | | | |
|---|---|---|---|---|---|---|---|
| | A | B | B1 | C | D | E | F |
| Ex. 1 | 67 | 10 | | 5 | 15 | 3 | |
| Ex. 2 | 62 | 10 | | 10 | 15 | 3 | |
| Ex. 3 | 67 | 10 | | 5 | 15 | | 3 |
| Ex. 4 | 72 | 5 | | 5 | 15 | 3 | |
| Ex. 5 | 62 | 10 | | 5 | 20 | 3 | |
| Comp. | 72 | 10 | | | 15 | 3 | |
| Ex. 1 | | | | | | | |
| Comp. | 77 | 10 | | 5 | 5 | 3 | |
| Ex. 2 | | | | | | | |
| Comp. | 52 | 10 | | 5 | 30 | 3 | |
| Ex. 3 | | | | | | | |
| Comp. | 67 | | 10 | 5 | 15 | 3 | |
| Ex. 4 | | | | | | | |
| Comp. | 72 | | 5 | 5 | 15 | 3 | |
| Ex. 5 | | | | | | | |
| Comp. | 57 | 20 | | 5 | 15 | 3 | |
| Ex. 6 | | | | | | | |
| Comp. | 85 | 10 | | 5 | | | |
| Ex. 7 | | | | | | | |
| Comp. | 70 | 10 | | 5 | 15 | | |
| Ex. 8 | | | | | | | |

A: Polyamide resin, Polyamide 6 (Domo chemicals)
B: Milled glass fiber, MF-300 (Daijin fiber glass Co., Ltd.)
B1: Glass fiber, CS-311 (KCC Corp.)
C: Glass bead, Microperl 050 (Sovitec Co., Ltd.)
D: Auxiliary resin, GP-35 (Styrolution Co., Ltd.)
E: Compatibilizer, PSX-0371 (Nippon Shokubai Co., Ltd.)
F: Compatibilizer, SAM-010 (Jiangsu Co., Ltd.)

### Experimental Example

The tensile strength, flexural strength, flexural modulus, impact strength, molding shrinkage, bending deformation, and light resistance of the polyamide resin compositions or specimens prepared in Examples and Comparative Examples were evaluated according to the following method, and the results are shown in the following Table 2.

Test Methods

Tensile strength: a specimen was produced and then tensile strength thereof was measured in accordance with ISO-527. A tensile strength of 50 MPa or greater was considered good, and a tensile strength less than 50 MPa was considered bad.

Flexural strength: a specimen was produced and then flexural strength thereof was measured in accordance with ISO-178. A flexural strength of 100 MPa or greater was considered good, and a flexural strength less than 100 MPa was considered bad.

Flexural modulus: a specimen was produced and then flexural modulus thereof was measured in accordance with ISO-178. A flexural strength of 2,700 MPa or greater was considered good, and a flexural strength less than 2,700 MPa was considered bad.

Impact strength: a specimen was produced and then impact strength thereof was measured in accordance with ISO-180. An impact strength of 3 KJ/m² or greater was considered good, and an impact strength less than 3 KJ/m² was considered bad.

Molding shrinkage: flow and vertical-direction shrinkage of 10 square specimens with a size of 60 mm*60 mm and a thickness of 2 mm were measured in accordance with ISO-294-4. Molding shrinkage in the resin flow direction of the injection-molded article and the direction perpendicular thereto of 0.6 to 0.7% was considered good.

Bending deformation: the bending deformation of the molded article that was released using a die having a cavity with a width of 100 mm, a length of 100 mm and a thickness of 2.0 mm was observed using the naked eye.

Light resistance: the light resistance of the polyamide resin composition was evaluated by performing a gray scale measurement thereon. The gray scale measurement was performed in accordance with JIS D0202-4.3 and SAE J2412. Gray scale is preferably grade 3 or higher. A gray scale of grade 3 or higher was considered good and a gray scale less than grade 3 was considered bad.

TABLE 2

| | | | | | Molding | | | | |
|---|---|---|---|---|---|---|---|---|---|
| | Tensile | Flexural | Flexural | Impact | shrinkage | | Bending | Light | |
| | strength | strength | modulus | strength | MD | TD | Visual | resistance | Remarks |
| Unit | Mpa | Mpa | Mpa | KJ/m² | (%) | (%) | evaluation | — | — |
| Ex. 1 | 70 | 110 | 3500 | 4.5 | 0.66 | 0.67 | ◯ | Satisfactory | |
| Ex. 2 | 60 | 105 | 3400 | 4.0 | 0.61 | 0.62 | ◯ | Satisfactory | |
| Ex. 3 | 66 | 113 | 3600 | 4.4 | 0.63 | 0.68 | ◯ | Satisfactory | |
| Ex. 4 | 59 | 103 | 3000 | 3.2 | 0.65 | 0.69 | ◯ | Satisfactory | |
| Ex. 5 | 60 | 107 | 3400 | 3.2 | 0.61 | 0.60 | ◯ | Satisfactory | |
| Comp. | 65 | 105 | 3550 | 3.5 | 0.65 | 0.80 | ◯ | Satisfactory | Unsatisfactory |
| Ex. 1 | | | | | | | | | molding shrinkage |
| Comp. | 62 | 105 | 3500 | 3.0 | 0.70 | 0.78 | ◯ | Satisfactory | Unsatisfactory |
| Ex. 2 | | | | | | | | | molding shrinkage |
| Comp. | 70 | 100 | 3200 | 3.5 | 0.50 | 0.55 | ◯ | Satisfactory | Unsatisfactory |
| Ex. 3 | | | | | | | | | molding shrinkage |
| Comp. | 104 | 147 | 4500 | 3.5 | 0.62 | 0.77 | X | Satisfactory | Unsatisfactory |
| Ex. 4 | | | | | | | | | molding shrinkage, |
| | | | | | | | | | deformation |
| Comp. | 85 | 127 | 3800 | 3.6 | 0.68 | 0.80 | X | Satisfactory | Unsatisfactory |
| Ex. 5 | | | | | | | | | molding shrinkage, |
| | | | | | | | | | deformation |
| Comp. | 74 | 116 | 3880 | 3.0 | 0.63 | 0.75 | ◯ | Satisfactory | Unsatisfactory |
| Ex. 6 | | | | | | | | | molding shrinkage |
| Comp. | 73 | 119 | 3500 | 2.2 | 0.79 | 0.84 | ◯ | Satisfactory | Unsatisfactory |
| Ex. 7 | | | | | | | | | molding shrinkage, |
| | | | | | | | | | unsatisfactory |
| | | | | | | | | | impact strength |
| Comp. | 55 | 100 | 3500 | 1.5 | 0.65 | 0.71 | ◯ | Satisfactory | Unsatisfactory |
| Ex. 8 | | | | | | | | | molding shrinkage, |
| | | | | | | | | | unsatisfactory |
| | | | | | | | | | impact strength |

As shown in Table 2, in Comparative Example 1, wherein from which the glass bead was omitted, the difference in molding shrinkage between the resin flow direction and the direction perpendicular to the resin flow direction increased. In addition, Comparative Example 2, in which the content of the auxiliary resin was reduced compared to Example 1, exhibited increased molding shrinkage. Comparative Example 3, in which the content of the auxiliary resin was increased, exhibited reduced molding shrinkage, and Comparative Examples 4 and 5, in which glass fiber was used in place of the milled glass fiber, exhibited improved mechanical strength, an increase in the difference in molding shrinkage between the resin flow direction and the direction perpendicular thereto, and bending deformation. Comparative Example 6, to which the milled glass fiber was added in a higher amount than in Example 1, exhibited improved mechanical strength, and a greater difference in molding shrinkage between the resin flow direction and the direction perpendicular thereto compared to Example 1, and Comparative Example 7, which did not include the auxiliary resin, exhibited increased resin molding shrinkage. Comparative Example 8, in which the compatibilizer was not used, exhibited reduced mechanical strength compared to Example 1.

According to various exemplary embodiments of the present invention, the polyamide molded article may have excellent mechanical strength.

According to various exemplary embodiments of the present invention, the polyamide molded article may be manufactured without a coating having excellent deformation resistance and light resistance.

According to various exemplary embodiments of the present invention, the polyamide molded article can be used as a material for automobile interior materials or defroster nozzles.

The effects of the present invention are not limited to those mentioned above. It should be understood that the effects of the present invention include all effects that can be inferred from the description of the present invention.

The present invention has been described in detail with reference to exemplary embodiments thereof. However, it will be appreciated by those skilled in the art that changes may be made in the embodiments without departing from the principles and spirit of the present invention, the scope of which is defined in the appended claims and their equivalents.

What is claimed is:

1. A polyamide resin composition comprising:
a polyamide resin;
an auxiliary resin;
a filler; and
a compatibilizer,
wherein the compatibilizer comprises a copolymer comprising maleimide.

2. The polyamide resin composition according to claim 1, wherein the polyamide resin comprises nylon 6, nylon 66, or combinations thereof.

3. The polyamide resin composition according to claim 1, wherein the polyamide resin has a relative viscosity of about 2.0 to 3.6.

4. The polyamide resin composition according to claim 1, wherein the auxiliary resin has a melt index of about 15 to 50 g/10 min according to ASTM D1238.

5. The polyamide resin composition according to claim 1, wherein the auxiliary resin comprises an acrylonitrile 1,3-butadiene styrene copolymer.

6. The polyamide resin composition according to claim 1, wherein the filler comprises a glass fiber, a glass bead, or combinations thereof.

7. The polyamide resin composition according to claim 6, wherein the glass fiber comprises a milled glass fiber and has a diameter of about 10 to 13 μm and a length of about 50 to 500 μm.

8. The polyamide resin composition according to claim 6, wherein the glass bead has a particle diameter of about 10 to 50 μm.

9. The polyamide resin composition according to claim 6, wherein the glass bead comprises calcium oxide (CaO), silicon dioxide (SiO₂), aluminum oxide (Al₂O₃), or combinations thereof.

10. The polyamide resin composition according to claim 1, wherein the compatibilizer comprises an N-phenylmaleimide-styrene copolymer, a styrene-maleic anhydride copolymer, or combinations thereof.

11. The polyamide resin composition according to claim 1, further comprising an additive.

12. The polyamide resin composition according to claim 11, wherein the polyamide resin composition comprises the additive in an amount of about 0.5 to 3 parts by weight based on 100 parts by weight of the polyamide resin.

13. The polyamide resin composition according to claim 1, wherein the polyamide resin composition comprises an amount of about 40 to 80% by weight of the polyamide resin, an amount of about 10 to 25% by weight of the auxiliary resin, an amount of about 9 to 30% by weight of the filler, and an amount of about 0.5 to 5% by weight of the compatibilizer, based on the total weight of the polyamide resin composition.

14. The polyamide resin composition according to claim 6, wherein the polyamide resin composition comprises an amount of about 40 to 80% by weight of the polyamide resin, an amount of about 10 to 25% by weight of the auxiliary resin, an amount of about 5 to 20% by weight of the glass fiber, an amount of about 4 to 10% by weight of the glass bead, and an amount of about 0.5 to 5% by weight of the compatibilizer, based on the total weight of the polyamide resin composition.

15. A molded article comprising a polyamide resin composition according to claim 1.

16. A vehicle comprising a molded article according to claim 15.
